(19) United States
(12) Patent Application Publication
(10) Pub. No.: US 2014/0273823 A1
(43) Pub. Date: Sep. 18, 2014

(54) NFC CAPABILITY FOR SMARTPHONES AND OTHER DEVICES

(71) Applicant: MASTERCARD INTERNATIONAL INCORPORATED, Purchase, NY (US)

(72) Inventor: Dan O'Sullivan, White Plains, NY (US)

(21) Appl. No.: 13/834,225

(22) Filed: Mar. 15, 2013

(51) Int. Cl. H04B 5/00; G06Q 20/32

(52) U.S. Cl. CPC H04B 5/0031; G06Q 20/3278
USPC 455/41.1

(57) ABSTRACT

The present disclosure provides an apparatus for converting a non-NFC capable device, such as a smart telephone or smartphone to a NFC capable device by electrically coupling the NFC capable device to NFC hardware. The NFC hardware can be a semiconductor chip. In one embodiment, a dongle is used that receives a portion of the NFC capable device. In another embodiment, the NFC capable device has a case that is used. The present disclosure also provides a method for converting a non-NFC device to a device having NFC capability.

### BACKGROUND OF THE DISCLOSURE

1. Field of the Disclosure

The present disclosure relates to near field communication (NFC) with smart telephones and other devices. More particularly, the present disclosure relates to the conversion of smartphone or other device not initially equipped for NFC to a device that has NFC capability.

2. Description of the Related Art

Electronic payment techniques have become popular. NFC, whether with a smartphone with a tag for transmitting a customer's payment information, has become a very popular payment method because of the savings in time and the reduction in paperwork. With the use of NFC, it is not necessary for a customer to carry a credit card that can become lost or stolen.

While many newer smartphones are equipped with NFC capabilities, namely having an NFC semiconductor chip and a software application on the smartphone, such newer smartphones are generally more expensive than phones without NFC capability. Further, there are many older smartphones and other devices, such as tablets and portable computers that do not have NFC capability. Many owners of these older devices desire to be upgraded to devices having NFC capabilities. However, these owners do not wish to expend funds for a new device.

There have been proposals for the conversion of smartphones to NFC capability. These proposals include some manner of placing and controlling an NFC chip at a location internal or external to the telephone. Internal locations include an NFC capable micro SD memory chip or NFC capable SIM card. External (or in some cases internal) locations include an NFC sticker. However, these approaches do not usually provide adequate radiation of NFC signals. Also, these approaches may have communication ranges that are not adequate, or unreliable, due to weak signal strength.

Therefore, there is a desired for an apparatus that upgrades a non-NFC smartphone or other device to NFC capability. Also, such an apparatus needs to be inexpensive, easy to connect, and, of course, must provide reliable NFC.

### SUMMARY OF THE DISCLOSURE

The present disclosure provides an apparatus for converting non-NFC devices or telephones to NFC capable devices.

The present disclosure also provides, in an embodiment, a “dongle” that accepts a portion of the device and is electrically connected to the device, and provides NFC capability. The dongle is electrically connected to the device to provide pass through capability for signals to or from the device.

The present disclosure further provides in another embodiment, a telephone case that connects to a telephone, and provides NFC capability.

The present disclosure still further provides for supplying the electrical energy needed for NFC from the non-NFC telephone or other device being converted to NFC use.

### BRIEF DESCRIPTION OF THE DRAWINGS

FIG. 1 is a perspective view of a NFC dongle used to convert a non-NFC telephone to an NFC telephone.

FIG. 2 is a top, plan view of the dongle of FIG. 1 without the phone in place.

FIG. 3 is a bottom view of the dongle of FIG. 2.

FIG. 4 is a perspective view of a case for a telephone used to convert a non-NFC telephone to an NFC capable telephone.

A component or a feature that is common to more than one drawing is indicated with the same reference number, or a similar reference numeral, in each of the drawings.

### DESCRIPTION OF THE PREFERRED EMBODIMENTS

Referring to the drawings and, in particular, FIG. 1, there is shown, by way of example, a non-NFC capable mobile smart telephone (“smartphone”) generally represented by reference numeral 100. The non-NFC smartphone 100 has a bottom portion that is configured to be received in an opening 102 of a member or dongle 104. Dongle 104 is used to convert telephone 100 to NFC use. Dongle 104 is formed of a nonmetallic material, such as a polymer. Dongle 104 includes a NFC hardware device, which can be a NFC semiconductor chip 106, to electrically couple to telephone 100. Telephone 100 is configured with appropriate software, as well known in the art, for configuring hardware device or NFC semiconductor chip 106 for NFC operation.

Referring to FIGS. 2 and 3, dongle 104 has an internal or inner surface 108. Inner surface 108 has an electrical connector 110 extending upwardly therefrom to fit into a corresponding connector on telephone 100, typically on the bottom of telephone 100. Such a connector includes, but is not limited to, a 30 pin Apple Inc. iOS connector, or an Apple Inc. Lightining™ connector. It is also possible for the connector to be a mini USB connector or a micro USB connector of telephone 100. In those situations, depending on the design of the telephone, dongle 104 is designed to receive a different portion of telephone 100.

Connector 110 connects to a conductor system extending through dongle 104, and to an electrical connector 112 that receives a mating connector that fits the connector on the bottom of telephone 100. Thus, dongle 104 acts as a pass-through device for allowing all normal electrical functions, such as charging and synchronization of the telephone, to occur while the software in the telephone provides NFC capabilities, utilizing NFC semiconductor chip 106. NFC semiconductor chip 106 is located at a position external to telephone 100. NFC semiconductor chip 106 provides reliable NFC capabilities. Numerous NFC transactions, such as paying for purchased products, can then be conducted by telephone 100 that would otherwise not have such capability absent dongle 104.

Dongle 104 can be configured with a flat bottom, except for a void at the position of electrical connector 112. With the flat bottom, dongle 104 can provide a base for supporting telephone 100 in the upright position shown in FIG. 1, when dongle 104 is positioned on a flat horizontal surface. Thus, it is not necessary to connect a mating electrical connector to electrical connector 112.

While dongle 104 provides adequate NFC capability, there is a situation where a user may not wish to carry an additional piece of hardware that is either with or connected to the telephone 100. However, the user would be more inclined to do so if the additional hardware served a purpose in addition to providing NFC capabilities.

Referring to FIG. 4, a telephone case 200 for use with a telephone (not shown in FIG. 4) can fit in opening 201 of case 200. A telephone not having NFC capabilities can be enabled for NFC use. Telephone case 200 is formed of a non-metallic material, such as a polymer. Telephone case 200 includes a NFC semiconductor chip 210 that may be embedded in the polymer or affixed to its surface. NFC semiconductor chip 210 is connected to a conductor system 208. Conductor system 208 extends to an electrical connector 206 that protrudes upwardly from the bottom internal surface 204 of case 200.

Electrical connector 206 is configured to fit, typically, into the bottom of a mobile telephone or other device (not shown in FIG. 4), when the bottom of the mobile telephone or other device is placed in opening 201, and the top of the mobile telephone or other device is then pivoted upward so that the entire mobile telephone or other device is received in case 200. Electrical connections between the mobile telephone or other device and NFC semiconductor chip 210 are thus completed. Electrical connector 206 can be, for example, a 30 pin Apple Inc. iOS connector, or an Apple Inc. Lightining™ connector. With appropriate changes in placement and design, it is also possible for the connector to be a mini USB connector or a micro USB connector for providing an electrical connection to the telephone or other device.

As described above with respect to the dongle of FIG. 1 through FIG. 3, connector 206 may extend through the wall of case 200. Case 200 has an internal surface 204 and, thus, provides pass through connectivity to an external connector (not shown) that couples the telephone or other device, via a cable (also not shown) to some external device, such as a charger for the telephone or other mobile device or to a computer with storage that is synchronized to the telephone or other device.

With appropriate software installed on a non-NFC smartphone or other device, NFC use of the originally non-NFC capable telephone or other device is enabled by the use of case 200.

An appropriate opening can be provided in case 200 to allow the user of the telephone received in case 200 to continue to use an earphone or headset to conduct, for example, a telephone conversation, while also conducting NFC transactions.

Case 200 has several advantages. While enabling NFC use, case 200 protects a telephone placed therein from excessive shock and vibration. This shock occurs especially if the telephone is dropped on a hard surface. NFC device or NFC semiconductor chip 206 can be of a relatively large size if needed to assure adequate radiation of NFC signals, and thus reliable NFC use. Further, if there is any malfunction of NFC device or NFC semiconductor chip 210, it is not necessary to open the telephone for access. A new case 200 can simply be substituted, and a test performed to be certain that NFC use is possible. A case 200 that has malfunctioned in some way, still has utility as a simple case. For example, such a case can be used by individuals, such as minors, who may not be offered NFC purchase privileges by their parents.

Both dongle 104 and case 200 offer the advantage of easily and inexpensively converting of a non-NFC telephone to NFC capabilities. No special tools are required to complete the conversion. Standard software enables the use of the non-NFC telephone as an NFC capable telephone can be downloaded in the usual manner for adding an application to a smartphone. Pass through capability for signals to the usual connectors on the smartphone is provided. No additional power source is required since power is supplied by the originally non-NFC telephone or other device.

The techniques described herein are exemplary. These techniques should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated feature, integer, step or component, but not precluding the presence of one or more other features, integers, steps or components, or groups thereof.

What is claimed is:

1. An apparatus for converting a non-NFC device to an NCF capable device comprising:
a member for enclosing at least a part of the device, the member having an inner surface and an outer surface;
an electrical conductor system for connection to a connector on the inner surface of the member, the connector on the inner surface being for connection to the NFC capable device; and
a NFC component associated with the member, the NFC component being coupled to the NFC capable device so that the NFC component is used for NFC by the NFC capable device.

2. The apparatus of claim 1, wherein the electrical conductor system extends to the outer surface of the member, the electrical conductor system including an electrical connector for receiving a mating electrical connector to connect to the NFC capable device.

3. The apparatus of claim 2, wherein the electrical connector on the NFC capable device is selected from the group consisting of a mini USB connector, a micro USB connector, and a 30 pin connector.

4. The apparatus of claim 2, wherein the electrical conductor system provides an electrical connection between the electrical connector and the NFC capable device.

5. The apparatus of claim 1, wherein the member fits around a bottom portion of the NFC capable device, and wherein the connector system and a connector on the NFC capable device is on a bottom portion of the NFC capable device.

6. The apparatus of claim 1, wherein the member has a generally flat bottom surface opposite a surface having an opening for receiving the NFC capable device, the member serving as a base for the NFC capable device when the generally flat bottom surface is placed on a flat level surface.

7. The apparatus of claim 1, wherein the NFC component is a semiconductor chip.

8. The apparatus of claim 1, wherein the NFC component has electrical power that is supplied by the NFC capable device.

9. The apparatus of claim 1, wherein the device is selected from the group consisting of a smartphone, a tablet, and a portable computer.

10. An apparatus for converting a non-NFC device to a NCF capable device comprising:
a case having an opening for receiving the device;
an electrical conductor system extending from the case for connection to a connector on or in the NFC capable device; and
an NFC component associated with the case, the NFC component being coupled to the NFC capable device by the electrical conductor system so that the NFC component is used for NFC by the NFC capable device.

11. The apparatus of claim 10, wherein the electrical conductor system includes a plug for plugging into the NFC capable device.

12. The apparatus of claim 11, wherein the plug is selected from the group consisting of mini USB connector, a micro USB connector, and a 30 pin connector.

13. The apparatus of claim 10, wherein the case comprises a connector extending from an internal surface of the case and positioned so that the connector engages a mating connector on or in the NFC capable device.

14. The apparatus of claim 13, wherein the connector extending from the internal surface of the case extends through a wall of the case to an additional connector, the additional connector providing a pass through capability for connecting the device to another device.

15. The apparatus of claim 10, wherein the NFC component has electrical power that is supplied by the NFC capable device.

16. The apparatus of claim 10, wherein the device is selected from the group consisting of a smartphone, a tablet and a portable computer.

17. A method for converting a non-NFC capable device to a NFC capable device comprising:
electrically coupling the device to a member containing NFC hardware, the member surrounding at least a portion of the device, and
using the NFC capable device to configure the NFC hardware for NFC use.

18. The method of claim 17, wherein the member is a dongle having a pass through conductor for connection to the NFC capable device.

19. The method of claim 17, wherein the NFC hardware is a NFC semiconductor chip.

20. The method of claim 17, wherein the member is selected from the group consisting of a dongle and a case for the device, the member having a pass through conductor for connection to the NFC capable device.
